(19) United States
(12) Patent Application Publication
(10) Pub. No.: US 2015/0376490 A1
(43) Pub. Date: Dec. 31, 2015

(54) Non-Aqueous Drilling Additive Useful To Stabilize Viscosity Over Change In Temperature

(71) Applicant: Elementis Specialties, Inc., East Windsor, NJ (US)

(72) Inventors: David DINO, Cranbury, NJ (US); Kamal Said Kamal ELSAYED, Plainsboro, NJ (US); Yanhui CHEN, Plainsboro, NJ (US); Jeffrey THOMPSON, Hightstown, NJ (US); Rajni Gupta, Princeton, NJ (US)

(73) Assignee: ELEMENTIS SPECIALTIES, INC., East Windsor, NJ (US)

(21) Appl. No.: 14/319,121

(22) Filed: Jun. 30, 2014

(51) Int. Cl. C09K 8/34

(52) U.S. Cl. CPC C09K 8/34

(57) ABSTRACT

A composition and method to control viscosity with respect to temperature for an oil-based drilling fluid by adding a polyamide drilling fluid additive to the oil based drilling fluid. In some embodiments, a polyamide drilling fluid additive includes a reaction product of (i) a carboxylic acid with a single carboxylic moiety; (ii) a carboxylic acid with two carboxylic moieties, a carboxylic acid with three carboxylic moieties and combinations thereof; and (iii) a polyamine having an amine functionality of two or more; and placing the placing the oil based drilling fluid into the subterranean formation.

### BACKGROUND OF THE INVENTION

Drilling fluids have been used since the very beginning of oil well drilling operations in the United States and drilling fluids and their chemistry are an important area for scientific and chemical investigations. Certain uses and desired properties of drilling fluids are reviewed in U.S. Pat. Nos. 7,799,742, 7,345,010, 6,339,048 and 6,462,096, issued to the assignee of this application, the entire disclosures of which are incorporated herein by reference.

Nevertheless, the demands of the oil-well drilling environment require increasing improvements in rheology control over broad temperature and shear ranges. This becomes particularly true, for example, as the search for new sources of gas and oil involves greater need to explore in deep water areas and to employ horizontal drilling techniques.

### SUMMARY OF THE INVENTION

The present disclosure provides for a composition and method of drilling in a subterranean formation. In some embodiments, the method provides the steps of: (a) providing an oil based drilling fluid by combining an oil based continuous phase with a drilling fluid additive, said drilling fluid additive comprising a polyamide having constituent units of (1) a first carboxylic acid unit having a single carboxylic moiety, (2) a second carboxylic acid unit selected from the group consisting of: a second carboxylic acid unit having two carboxylic moieties, a second carboxylic acid unit having three carboxylic moieties and combinations thereof and (3) a polyamine unit having at least two primary amino groups and optionally at least one secondary amino group, wherein a viscosity measurement of the oil based drilling fluid does not change more than about ±20% between a measurement at a temperature of 120° F. and a measurement at a temperature of 150° F. The oil based drilling fluid is then placed into the subterranean formation. In some such embodiments, the polyamide drilling fluid additive is added to the oil-based drilling fluid at a concentration ranging from 0.5 ppb to 5 ppb. In some such embodiments, the oil based continuous phase comprises: diesel oil, mineral oil, synthetic oil, vegetable oil, fish oil, paraffinics, ester-based oils and combinations thereof. In some embodiments the method includes a step of adding one or more emulsifiers to the oil-based drilling fluid. In some embodiments the method includes a step of adding a fluid loss reducing additive to the oil-based drilling fluid.

In some other embodiments, the method provides the steps of: (a) providing an oil based drilling fluid by combining an oil based continuous phase with a drilling fluid additive, said drilling fluid additive comprising a polyamide which is a reaction product of (1) a first carboxylic acid having a single carboxylic moiety, (2) a second carboxylic acid selected from the group consisting of: a second carboxylic acid having two carboxylic moieties, a second carboxylic acid having three carboxylic moieties and combinations thereof and (3) a polyamine having at least two primary amino groups and optionally at least one secondary amino group, wherein a viscosity measurement of the oil based drilling fluid does not change more than about ±20% between a measurement at a temperature of 120° F. and a measurement at a temperature of 150° F. The oil based drilling fluid is then placed into the subterranean formation. In some such embodiments, the polyamide drilling fluid additive is added to the oil-based drilling fluid at a concentration ranging from 0.5 ppb to 5 ppb. In some such embodiments, the oil based continuous phase comprises: diesel oil, mineral oil, synthetic oil, vegetable oil, fish oil, paraffinics, ester-based oils and combinations thereof. In some embodiments the method includes a step of adding one or more emulsifiers to the oil-based drilling fluid. In some embodiments the method includes a step of adding a fluid loss reducing additive to the oil-based drilling fluid.

In some embodiments the first carboxylic acid or carboxylic acid unit is derived from one or more compounds of the formula R¹—COOH wherein R¹ is a saturated or unsaturated hydrocarbon having from 8 carbon atoms to 22 carbon atoms. In some such embodiments, R¹ is an unsaturated hydrocarbon having from 8 carbon atoms to 22 carbon atoms and wherein R¹ is optionally substituted with one or more hydroxyl groups. In some embodiments R¹ is a saturated or unsaturated hydrocarbon having from 12 carbon atoms to 22 carbon atoms. In some such embodiments, R¹ is an unsaturated hydrocarbon having from 12 carbon atoms to 22 carbon atoms and wherein R¹ is optionally substituted with one or more hydroxyl groups.

In still yet other embodiments, the carboxylic acid unit having one carboxylic moiety is derived from a monocarboxylic acid selected from the group consisting of: dodecanoic acid, tetradecanoic acid, hexadecanoic acid, octadecanoic acid, eicosanoic acid, docosanoic acid, 12-hydroxy-octadecanoic acid, and 12-hydroxy-9-cis-octadecenoic acid and mixtures thereof.

In yet other embodiments, the carboxylic acid unit having two carboxylic moieties is derived from a dimer fatty acid. In some such embodiments, the dimer fatty acid is selected from the group consisting of hydrogenated, partially hydrogenated and non-hydrogenated dimer acids with from about 20 to about 48 carbon atoms.

In some embodiments, the polyamine unit is derived from a linear or branched aliphatic or aromatic diamine having from 2 to 36 carbon atoms. In some such embodiments, the polyamine unit is derived from a polyamine comprising ethylenediamine, tetramethylenediamine, tetraethylenepentamine, pentamethylenediamine, hexamethylenediamine, diethylenetriamine, metaxylene diamine and mixtures thereof.

In some embodiments, the method comprises the step of adding one or more emulsifiers to the oil-based drilling fluid.

In some embodiments, the method comprises the step of adding an organoclay to the oil-based drilling fluid. In other embodiments, the method comprises the step of adding a non-organoclay rheological additive to the oil-based drilling fluid.

### DETAILED DESCRIPTION OF THE EMBODIMENTS

The present invention provides for compositions and methods to control viscosity with respect to temperature for an oil-based drilling fluid by adding a polyamide drilling fluid additive to the oil based drilling fluid. In some embodiments, a polyamide drilling fluid additive includes a reaction product of (i) a first carboxylic acid having a single carboxylic moiety; (ii) a second carboxylic acid selected from the group consisting of: a carboxylic acid having two carboxylic moieties, a second carboxylic acid having three carboxylic acid moieties and combinations thereof; and (iii) a polyamine having at least two primary amino groups and optionally at least one secondary amino group. In some embodiments, the low shear viscosity of an oil based drilling fluid containing such polyamide drilling fluid additive, does not change more than about ±20% between a measurement at a temperature of 120° F. and a measurement at a temperature of 150° F. In some embodiments, the low shear viscosity of an oil based drilling fluid containing such polyamide drilling fluid additive, does not change more than about ±10% between a measurement at a temperature of 120° F. and a measurement at a temperature of 150° F. In some embodiments, the low shear viscosity of an oil based drilling fluid containing such polyamide drilling fluid additive, does not change more than about ±5% between a measurement at a temperature of 120° F. and a measurement at a temperature of 150° F.

In other embodiments, a polyamide drilling fluid additive consists of a reaction product of (i) a first carboxylic acid having a single carboxylic moiety; (ii) a second carboxylic acid selected from the group consisting of: a second carboxylic acid having two carboxylic moieties, a second carboxylic acid having three carboxylic acid moieties and combinations thereof; and (iii) a polyamine having at least two primary amino groups and optionally at least one secondary amino group. In some embodiments, the low shear viscosity of an oil based drilling fluid containing such polyamide drilling fluid additive, does not change more than about ±10% between a measurement at a temperature of 120° F. and a measurement at a temperature of 150° F. In some embodiments, the low shear viscosity of an oil based drilling fluid containing such polyamide drilling fluid additive, does not change more than about ±5% between a measurement at a temperature of 120° F. and a measurement at a temperature of 150° F.

In yet other embodiments, the polyamide drilling fluid additive includes a polyamide having constituent units of: (i) a first carboxylic acid unit having a single carboxylic moiety; (ii) a second carboxylic acid unit selected from the group consisting of: a second carboxylic acid unit having two carboxylic moieties, a second carboxylic acid unit having three carboxylic acid moieties and combinations thereof; and (iii) a polyamine unit having at least two primary amino groups and optionally at least one secondary amino group. In some embodiments, the low shear viscosity of an oil based drilling fluid containing such polyamide drilling fluid additive, does not change more than about ±10% between a measurement at a temperature of 120° F. and a measurement at a temperature of 150° F. In some embodiments, the low shear viscosity of an oil based drilling fluid containing such polyamide drilling fluid additive, does not change more than about ±5% between a measurement at a temperature of 120° F. and a measurement at a temperature of 150° F.

In still other embodiments, the polyamide drilling fluid additive includes a polyamide consisting of constituent units of: (i) a first carboxylic acid unit having a single carboxylic moiety; (ii) a second carboxylic acid unit selected from the group consisting of: a second carboxylic acid unit having two carboxylic moieties, a second carboxylic acid unit having three carboxylic acid moieties and combinations thereof; and (iii) a polyamine unit having at least two primary amino groups and optionally at least one secondary amino group. In some embodiments, the low shear viscosity of an oil based drilling fluid containing such polyamide drilling fluid additive, does not change more than about ±10% between a measurement at a temperature of 120° F. and a measurement at a temperature of 150° F. In some embodiments, the low shear viscosity of an oil based drilling fluid containing such polyamide drilling fluid additive, does not change more than about ±5% between a measurement at a temperature of 120° F. and a measurement at a temperature of 150° F.

For the purposes of this disclosure, polyamides include bisamide and polyamide compositions. The carboxylic acids and polyamines which may be used to produce various embodiments of a polyamide as a reaction products or from which the constituent units are derived, and used in the methods described herein, are described below.

Carboxylic Acids

According to some embodiments, a first carboxylic acid reactant and/or carboxylic acid from which a carboxylic acid unit is derived (individually or collectively referred to herein as “carboxylic acid”) includes various carboxylic acids having a single carboxylic moiety. In one embodiment, the first carboxylic acid includes one or more compounds of the formula R¹—COOH wherein R¹ is a saturated or unsaturated hydrocarbon having from 8 carbon atoms to 22 carbon atoms. In another embodiment, R¹ is an unsaturated hydrocarbon having from 8 carbon atoms to 22 carbon atoms and wherein R¹ is optionally substituted with one or more hydroxyl groups. In one embodiment, the first carboxylic acid includes one or more compounds of the formula R¹—COOH wherein R¹ is a saturated or unsaturated hydrocarbon having from 12 carbon atoms to 22 carbon atoms. In another embodiment, R¹ is an unsaturated hydrocarbon having from 12 carbon atoms to 22 carbon atoms and wherein R¹ is optionally substituted with one or more hydroxyl groups. In one embodiment, the first carboxylic acid includes one or more compounds of the formula R¹—COOH wherein R¹ is a saturated or unsaturated hydrocarbon having from 12 carbon atoms to 18 carbon atoms. In another embodiment, R¹ is an unsaturated hydrocarbon having from 12 carbon atoms to 18 carbon atoms and wherein R¹ is optionally substituted with one or more hydroxyl groups.

In yet another embodiment, the first carboxylic acid includes one or more of the following monocarboxylic acids:butanoic acid, hexanoic acid, octanoic acid and decanoic acid, dodecanoic acid, tetradecanoic acid, hexadecanoic acid, octadecanoic acid, eicosanoic acid, docosanoic acid, 12-hydroxy-octadecanoic acid, and 12-hydroxy-9-cis-octadecenoic acid and mixtures thereof. In other embodiments, the first carboxylic acid includes one or more of the following monocarboxylic acids:dodecanoic acid, octadecanoic acid, docosanoic acid, 12-hydroxy-octadecanoic acid, and 12-hydroxy-9-cis-octadecenoic acid and mixtures thereof. In one embodiment, the first carboxylic acid is dodecanoic acid. In another embodiment, the first carboxylic acid is docosanoic acid. In another embodiment, the first carboxylic acid is 12-hydroxy-octadecanoic acid.

In some embodiments the first carboxylic acid is derived from a natural oil, such as Coconut oil, Palm kernel oil, Palm oil, Cottonseed oil, Wheat germ oil, Soybean oil, Olive oil, Corn oil, Sunflower oil, Safflower oil, Hemp oil, Canola/Rapeseed oil and combinations thereof.

In some embodiments wherein the first carboxylic acid is derived from a natural oil, the first carboxylic acid includes a mixture of two or more monocarboxylic acids. For example, coconut oil fatty acid can include a mixture of caproic acid, caprylic acid, capric acid, lauric acid (dodecanoic acid), myristic acid (tetradecanoic acid), palmitic acid (hexadecanoic acid), stearic acid (n-octadecanoic acid), oleic acid, linoleic acid, arachidic acid (eicosanoic acid and combinations thereof.

According to some embodiments, the first carboxylic acid may include a mixture of two or more carboxylic acids wherein the first carboxylic acid includes one or more compounds of the formula R¹—COOH wherein R¹ is a saturated or unsaturated hydrocarbon having from 12 carbon atoms to 22 carbon atoms and one or more compounds of the formula R²—(COOH)₂ wherein R² is a saturated or unsaturated hydrocarbon having from 6 carbon atoms to 10 carbon atoms. Examples of such carboxylic acids having two carboxylic acid moieties and 6 carbon atoms to 10 carbon atoms include: adipic acid, pimelic acid, suberic acid, azelaic acid, sebacic acid and combinations thereof.

In yet another embodiment, the second carboxylic acid may have two carboxylic acid groups and may be a dimer acid. In some embodiments, the carboxylic acid includes dimer acids of C₁₆ and/or C₁₈ fatty acids. In certain embodiments, such dimer acids are fully hydrogenated, partially hydrogenated, or not hydrogenated at all. In some embodiments, dimer acids include products resulting from the dimerization of C₁₆ to C₁₈ unsaturated fatty acids.

In some embodiments, the dimer carboxylic acid has two carboxylic acid moieties and has an average of about 18 to about 48 carbon atoms. In some embodiments, the dimer carboxylic acid has two carboxylic acid moieties and has an average of about 20 to 40 carbon atoms. In one embodiment, the dimer carboxylic acid has two carboxylic acid moieties and has an average of about 36 carbon atoms.

In certain embodiments, a dimer carboxylic acid may be prepared from C₁₈ fatty acids, such as oleic acids. Examples of suitable dimer acids are described in U.S. Pat. Nos. 2,482,760, 2,482,761, 2,731,481, 2,793,219, 2,964,545, 2,978,468, 3,157,681, and 3,256,304, the entire disclosures of which are incorporated herein by reference.

Examples of suitable dimer acids include the Empol® product line available from Cognis Inc. (eg: Empol® 1061), and Pripol® dimer acids available from Croda (eg: Pripol® 1013).

In yet another embodiment, the second carboxylic acid may have three carboxylic acid groups and may be a trimer acid. In some embodiments, the carboxylic acid includes trimer acids of C₁₆ and/or C₁₈ fatty acids. In certain embodiments, such trimer acids are fully hydrogenated, partially hydrogenated, or not hydrogenated at all. In some embodiments, trimer acids include products resulting from the trimerization of C₁₆ to C₁₈ unsaturated fatty acids.

In some embodiments, the trimer carboxylic acid has three carboxylic acid moieties and has an average of about 27 to about 72 carbon atoms. In some embodiments, the trimer carboxylic acid has three carboxylic acid moieties and has an average of about 30 to 60 carbon atoms. In one embodiment, the trimer carboxylic acid has three carboxylic acid moieties and has an average of about 54 carbon atoms.

In certain embodiments, a trimer carboxylic acid may be prepared from C₁₈ fatty acids, such as oleic acids.

Examples of suitable trimer acids include the Pripol® trimer acids available from Croda (eg: Pripol® 1040).

Many commercially available polymerized fatty acids contain a mixture of monomer, dimer, and trimer acids. In some embodiments, a polymerized carboxylic acid has a dimer content of at least about 80 wt. %. In some embodiments, a polymerized carboxylic acid has a dimer content of at least about 90 wt. %. In some embodiments, a polymerized carboxylic acid has a dimer content of at least about 95 wt. %. In some embodiments, a polymerized carboxylic acid has a trimer content of at least about 75 wt. %.

An example of a polymerized carboxylic acid includes Empol® 1061, which has a dimer carboxylic acid content of 92.5 wt. %-95.5 wt. %, a trimer carboxylic acid content of 1.5 wt. %-3.5 wt. % and a monocarboxylic acid content of 2.5 wt. %-5.0 wt. %. Another example of a polymerized carboxylic acid includes Pripol® 1013, which has a dimer carboxylic acid content of 95 wt. %-98 wt. %, a trimer carboxylic acid content of 2 wt. %-4 wt/%, a monocarboxylic acid content of about 0.2 wt. %. A further example of a polymerized carboxylic acid includes Pripol® 1040, which has a trimer carboxylic acid content of at least 75 wt. %.

Polyamines

Each of the carboxylic acids described above may be used in combination with the polyamines described below.

According to some embodiments, the polyamine reactant and/or polyamine from which a polyamine unit is derived (individually or collectively referred to herein as “polyamine”) includes a polyamine having an amine functionality of two or more. In one embodiment, the polyamine includes a linear or branched aliphatic or aromatic diamine having from 2 to 36 carbon atoms. Di-, tri-, and polyamines and their combinations may be suitable. Examples of such amines include one or more of the following di- or triamines: ethylenediamine, tetramethylenediamine, tetraethylenepentamine, pentamethylenediamine, hexamethylenediamine, diethylenetriamine, metaxylene diamine, dimer diamines and mixtures thereof. In yet another embodiment, the polyamine includes one or more of the following: ethylenediamine, tetraethylenepentamine, hexamethylenediamine, diethylenetriamine, metaxylene diamine, dimer diamines and mixtures thereof. In another embodiment, the polyamine includes a polyethylene polyamine of one or more of the following: ethylenediamine, hexamethylenediamine, tetraethylenepentamine, diethylenetriamine and mixtures thereof.

In some embodiments, di-, tri-, and polyamines and their combinations are suitable for use in this invention. In such embodiments, polyamines include ethylenediamine, diethylenetriamine, tetraethylenepentamine, triethylenetetramine, tetraethylenepentamine and other members of this series. In one such embodiment, a suitable triamine is diethylenetramine (DETA). DETA has been assigned a CAS No. of 111-40-0 and is commercially available from Huntsman International.

In other embodiments, a suitable polyamine includes aliphatic dimer diamine, cycloaliphatic dimer diamine, aromatic dimer diamine and mixtures thereof and Priamine® 1074 from Croda Coatings and Polymers.

Exemplary Drilling Fluid Additive Compositions

In some embodiments, the polyamide drilling fluid additive includes compositions based on a polyethylene polyamine. In one such embodiment, the polyamide drilling fluid includes a composition having constituent units derived from: coconut fatty acid, dimer acid and diethylene triamine. In another such embodiment, the polyamide drilling fluid additive includes a composition having constituent units derived from: coconut fatty acid, a trimer acid, and diethylene triamine. In another such embodiment, the polyamide drilling fluid additive includes a composition having constituent units derived from: coconut fatty acid, a mixture of dimer and trimer acids, and diethylene triamine.

In some embodiments, the polyamide drilling fluid additive includes compositions based on a polyethylene polyamine. In one such embodiment, the polyamide drilling fluid includes a composition having constituent units derived from: palmitic acid, dimer acid, and diethylene triamine. In another such embodiment, the polyamide drilling fluid additive includes a composition having constituent units derived from: coconut fatty acid, a trimer acid, and diethylene triamine. In another such embodiment, the polyamide drilling fluid additive includes a composition having constituent units derived from: coconut fatty acid, a mixture of dimer and trimer acids, and diethylene triamine.

In some embodiments, the polyamide drilling fluid additive includes compositions based on a polyethylene polyamine. In one such embodiment, the polyamide drilling fluid includes a composition having constituent units derived from: coconut fatty acid, dimer acid, and tetraethylenepentamine. In another such embodiment, the polyamide drilling fluid additive includes a composition having constituent units derived from: coconut fatty acid, a trimer acid, and tetraethylenepentamine. In another such embodiment, the polyamide drilling fluid additive includes a composition having constituent units derived from: coconut fatty acid, a mixture of dimer and trimer acids, and tetraethylenepentamine.

In some embodiments, the polyamide drilling fluid additive includes compositions based on a polyethylene polyamine. In one such embodiment, the polyamide drilling fluid includes a composition having constituent units derived from: palmitic acid, dimer acid, and tetraethylenepentamine. In another such embodiment, the polyamide drilling fluid additive includes a composition having constituent units derived from: palmitic acid, a trimer acid, and tetraethylenepentamine. In another such embodiment, the polyamide drilling fluid additive includes a composition having constituent units derived from: palmitic acid, a mixture of dimer and trimer acids, and tetraethylenepentamine.

In other embodiments, the polyamide drilling fluid additive includes a composition having constituent units derived from: a monocarboxylic acid, a C₁₆-C₁₈ dimer carboxylic acid, and diethylene triamine. In other embodiments, the polyamide drilling fluid additive includes a composition having constituent units derived from: a monocarboxylic acid, a C₁₆-C₁₈ trimer carboxylic acid and diethylene triamine. In still other embodiments, the polyamide drilling fluid additive includes a composition having constituent units derived from: a monocarboxylic acid, a C₁₆-C₁₈ dimer carboxylic acid, a C₁₆-C₁₈ trimer carboxylic acid, and diethylene triamine.

In other embodiments, the polyamide drilling fluid additive includes a composition having constituent units derived from: a C₁₄-C₁₈ monocarboxylic acid, a C₁₆-C₁₈ dimer carboxylic acid, and diethylene triamine. In other embodiments, the polyamide drilling fluid additive includes a composition having constituent units derived from: a C₁₄-C₁₈ monocarboxylic acid, a C₁₆-C₁₈ trimer carboxylic acid, and diethylene triamine. In still other embodiments, the polyamide drilling fluid additive includes a composition having constituent units derived from: a C₁₄-C₁₈ monocarboxylic acid, a C₁₆-C₁₈ dimer carboxylic acid, a C₁₆-C₁₈ trimer carboxylic acid and diethylene triamine.

In other embodiments, the polyamide drilling fluid additive includes a composition having constituent units derived from: a C₁₆ monocarboxylic acid, a C₁₆-C₁₈ dimer carboxylic acid, and diethylene triamine. In other embodiments, the polyamide drilling fluid additive includes a composition having constituent units derived from: a C₁₆ monocarboxylic acid, a C₁₆-C₁₈ trimer carboxylic acid, and diethylene triamine. In still other embodiments, the polyamide drilling fluid additive includes a composition having constituent units derived from: a C₁₆ monocarboxylic acid, a C₁₆-C₁₈ dimer carboxylic acid, a C₁₆-C₁₈ trimer carboxylic acid, and diethylene triamine.

In other embodiments, the polyamide drilling fluid additive includes a composition having constituent units derived from: a monocarboxylic acid, a C₁₆-C₁₈ dimer carboxylic acid, and tetraethylenepentamine. In other embodiments, the polyamide drilling fluid additive includes a composition having constituent units derived from: a monocarboxylic acid, a C₁₆-C₁₈ trimer carboxylic acid, and tetraethylenepentamine. In still other embodiments, the polyamide drilling fluid additive includes a composition having constituent units derived from: a monocarboxylic acid, a C₁₆-C₁₈ dimer carboxylic acid, a C₁₆-C₁₈ trimer carboxylic acid, and tetraethylenepentamine.

In other embodiments, the polyamide drilling fluid additive includes a composition having constituent units derived from: a C₁₄-C₁₈ monocarboxylic acid, a C₁₆-C₁₈ dimer carboxylic acid, and tetraethylenepentamine. In other embodiments, the polyamide drilling fluid additive includes a composition having constituent units derived from: a C₁₄-C₁₈ monocarboxylic acid, a C₁₆-C₁₈ trimer carboxylic acid, and tetraethylenepentamine. In still other embodiments, the polyamide drilling fluid additive includes a composition having constituent units derived from: a C₁₄-C₁₈ monocarboxylic acid, a C₁₆-C₁₈ dimer carboxylic acid, a C₁₆-C₁₈ trimer carboxylic acid, and tetraethylenepentamine.

In other embodiments, the polyamide drilling fluid additive includes a composition having constituent units derived from: a C₁₆ monocarboxylic acid, a C₁₆-C₁₈ dimer carboxylic acid, and tetraethylenepentamine. In other embodiments, the polyamide drilling fluid additive includes a composition having constituent units derived from: a C₁₆ monocarboxylic acid, a C₁₆-C₁₈ trimer carboxylic acid, and tetraethylenepentamine. In still other embodiments, the polyamide drilling fluid additive includes a composition having constituent units derived from: a C₁₆ monocarboxylic acid, a C₁₆-C₁₈ dimer carboxylic acid, a C₁₆-C₁₈ trimer carboxylic acid, and tetraethylenepentamine.

In other embodiments, the polyamide drilling fluid additive includes a composition having constituent units derived from: a monocarboxylic acid, a C₁₆-C₁₈ dimer carboxylic acid, and ethylene diamine. In other embodiments, the polyamide drilling fluid additive includes a composition having constituent units derived from: a monocarboxylic acid, a C₁₆-C₁₈ trimer carboxylic acid, and ethylene diamine. In still other embodiments, the polyamide drilling fluid additive includes a composition having constituent units derived from: a monocarboxylic acid, a C₁₆-C₁₈ dimer carboxylic acid, a C₁₆-C₁₈ trimer carboxylic acid, and ethylene diamine.

In one embodiment, the polyamide drilling fluid additive includes a composition based on a dimer diamine. In one such embodiment, the polyamide drilling fluid includes a composition having constituent units derived from: a C₁₄-C₁₈ monocarboxylic acid, a C₁₆-C₁₈ dimer carboxylic acid, and ethylene diamine. In another such embodiment, the polyamide drilling fluid includes a composition having constituent units derived from: a C₁₄-C₁₈ monocarboxylic acid, a C₁₆-C₁₈ dimer carboxylic acid, a C₁₆-C₁₈ trimer carboxylic acid, and ethylene diamine. In still another embodiment, the polyamide drilling fluid includes a composition having constituent units derived from: a C₁₄-C₁₈ monocarboxylic acid, a C₁₆-C₁₈ trimer carboxylic acid, and ethylene diamine.

In other embodiments, the polyamide drilling fluid additive includes a composition having constituent units derived from: a C₁₆ monocarboxylic acid, a C₁₆-C₁₈ dimer carboxylic acid, and ethylene diamine. In other embodiments, the polyamide drilling fluid additive includes a composition having constituent units derived from: a C₁₆ monocarboxylic acid, a C₁₆-C₁₈ trimer carboxylic acid, and ethylene diamine. In still other embodiments, the polyamide drilling fluid additive includes a composition having constituent units derived from: a C₁₆ monocarboxylic acid, a C₁₆-C₁₈ dimer carboxylic acid, a C₁₆-C₁₈ trimer carboxylic acid, and ethylene diamine.

Each of the polyamide drilling fluid additives described herein, may be used in oil based drilling fluids described below.

Making the Drilling Fluid Additive

Specifics on processing of polyamines and carboxylic acids are well known and can be used in making the reaction product for incorporation in the drilling fluid additive. In some embodiments, the molar ratio between the amine functional group and carboxyl functional group of monocarboxylic acid is about 4:1 to about 1:0.5. In some embodiments, the molar ratio between the amine functional group and carboxyl functional group of monocarboxylic acid is about 3:1 to about 1:1. In some embodiments, the molar ratio between the amine functional group and carboxyl functional group of monocarboxylic acid is: about 3:1; about 2:1; and about 1:1. In some embodiments, the molar ratio between the amine functional group and carboxyl functional group of monocarboxylic acid is about 1:1. In some embodiments, mixtures of more than one monocarboxylic acid and/or more than one polyamine can be used.

In some embodiments, the molar ratio between the carboxyl functional group of monocarboxylic acid and the amine functional group and is about 5:1 to about 3:1. In some embodiments, the molar ratio between the carboxyl functional group of monocarboxylic acid and the amine functional group and carboxyl functional group of monocarboxylic acid is about 3:1. In some embodiments, mixtures of more than one monocarboxylic acid and/or more than one polyamine can be used. (these ratios seem to be from the IP expansion patent, for this LSRRM polyamide additive, we have the ratio of amine/acid functional groups at 5:3 (fatty acid/dimer acid/deta=300/100/100), these ranges need to be reset)

In some embodiments, the molar ratio between the amine functional group and carboxyl functional group of dicarboxylic acid and tricarboxylic acid is about 2:1 to about 1:1. In some embodiments, the molar ratio between the amine functional group and carboxyl functional group of dicarboxylic acid and tricarboxylic acid is about 1:1. In some embodiments, mixtures of more than one dicarboxylic acid, more than one tricarboxylic acid, more than one of each of dicarboxylic acid and tricarboxylic acid and/or more than one polyamine can be used.

Preparation of the Drilling Fluids

In some embodiments, compositions according to the present invention may be used as an additive to oil-based drilling fluids. In some embodiments, compositions according to the present invention may be used as an additive for oil-based invert emulsion drilling fluids employed in a variety of drilling applications.

The term oil-based drilling fluid is defined as a drilling fluid in which the continuous phase is hydrocarbon based. Oil-based drilling fluids formulated with over 5% water or brine may be classified as oil-based invert emulsion drilling fluids. In some embodiments, oil-based invert emulsion drilling fluids may contain water or brine as the discontinuous phase in any proportion up to about 50%. Oil muds may include invert emulsion drilling fluids as well as all oil based drilling fluids using synthetic, refined or natural hydrocarbon base as the external phase.

According to some embodiments, a process for preparing invert emulsion drilling fluids (oil muds) involves using a mixing device to incorporate the individual components making up that fluid. In some embodiments, primary and secondary emulsifiers and/or wetting agents (surfactant mix) are added to the base oil (continuous phase) under moderate agitation. The water phase, typically a brine, may be added to the base oil/surfactant mix along with alkalinity control agents and acid gas scavengers. In some embodiments, rheological additives as well as fluid loss control materials, weighting agents and corrosion inhibition chemicals may also be included. The agitation may then be continued to ensure dispersion of each ingredient and homogenize the resulting fluidized mixture.

A drilling fluid can be characterized by its mud weight, mass per unit volume. Mud weight can be reported in units of pounds/gallon (“ppg”). The mud weight typically ranges from 8 ppg up to 18 ppg depending upon the base oil of the drilling fluid.

Oil-Based Phase

According to some embodiments, the base oil (or interchangeably) continuous phase includes diesel oil, mineral oil, synthetic oil, vegetable oil, fish oil, paraffinics, and/or ester-based oils which can all be used as single components or as blends.

Brine Content

In some embodiments, water in the form of brine is often used in forming the internal phase of the drilling fluids. According to some embodiments, water can be defined as an aqueous solution which can contain from about 10 to 350,000 parts-per-million of metal salts such as lithium, sodium, potassium, magnesium, cesium, or calcium salts. In some embodiments, brines used to form the internal phase of a drilling fluid according to the present invention can also contain about 5% to about 35% by weight calcium chloride and may contain various amounts of other dissolved salts such as sodium bicarbonate, sodium sulfate, sodium acetate, sodium borate, potassium chloride, sodium chloride or formates (such as sodium, calcium, or cesium). In some embodiments, glycols or glycerin can be used in place of or in addition to brines.

In some embodiments, the ratio of water (brine) to oil in the emulsions according to the present invention may provide as high of brine content as possible while still maintaining a stable emulsion. In some embodiments, suitable oil/brine ratios may be in the range of about 97:3 to about 50:50. In some embodiments, suitable oil/brine ratios may be in the range of about 90:10 to about 60:40, or about 80:20 to about 70:30. In some embodiments, the preferred oil/brine ratio may depend upon the particular oil and mud weight. According to some embodiments, the water content of a drilling fluid prepared according to the teachings of the invention may have an aqueous (water) content of about 0 to 50 volume percent.

Organoclay Rheology Modifiers and Rheology Modifiers Other than Organoclays

In some embodiments, the drilling fluid additive includes an organoclay rheology modifier. According to some embodiments, organoclays made from at least one of bentonite, hectorite and attapulgite clays are added to the drilling fluid additive. In one embodiment, the organoclay is based on bentonite, hectorite or attapulgite exchanged with a quaternary ammonium salt having the following formula:

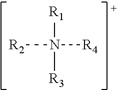

where R₁, R₂, R₃ or R₄ are selected from (a) benzyl or methyl groups; (b) linear or branched long chain alkyl radicals having 10 to 22 carbon atoms; (c) aralkyl groups such as benzyl and substituted benzyl moieties including fused ring moieties having linear or branched 1 to 22 carbon atoms in the alkyl portion of the structure; (d) aryl groups such as phenyl and substituted phenyl including fused ring aromatic substituents; (e) beta, gamma unsaturated groups; and (f) hydrogen.

In another embodiment, the organoclay rheology modifier is based on bentonite, hectorite or attapulgite exchanged with a quaternary ammonium ion including dimethyl bis[hydrogenated tallow] ammonium chloride (“2M2HT”), benzyl dimethyl hydrogenated tallow ammonium chloride (“B2MHT”), trimethyl hydrogenated tallow ammonium chloride (“3MHT”) and methyl benzyl bis[hydrogenated tallow] ammonium chloride (“MB2HT”).

There are a large number of suppliers of such clays in addition to Element is Specialties' BENTONE® product line including Rockwood Specialties, Inc. and Sud Chemie GmbH.

In addition to or in place of organoclays, polymeric rheological additives, such as THIXATROL® DW can be added to the drilling fluid. Examples of suitable polymeric rheological additives are described in U.S. Pat. Nos. 7,345,010; 7,799,742; and 7,906,461, each incorporated by reference herein in its entirety.

Emulsifiers

According to some embodiments, an emulsifier can also be added to the drilling fluid in order to form a more stable emulsion. The emulsifier may include organic acids, including but not limited to the monocarboxyl alkanoic, alkenoic, or alkynoic fatty acids containing from 3 to 20 carbon atoms, and mixtures thereof. Examples of this group of acids include stearic, oleic, caproic, capric and butyric acids. In some embodiments, adipic acid, a member of the aliphatic dicarboxylic acids, can also be used. According to some embodiments, suitable surfactants or emulsifiers include fatty acid calcium salts and lecithin. In other embodiments, suitable surfactants or emulsifiers include oxidized tall oil, polyaminated fatty acids, and partial amides of fatty acids.

In some embodiments, heterocyclic additives such as imidazoline compounds may be used as emulsifiers and/or wetting agents in the drilling muds. In other embodiments, alkylpyridines may be used to as emulsifiers and/or wetting agents in the drilling muds.

Industrially obtainable amine compounds for use as emulsifiers may be derived from the epoxidation of olefinically unsaturated hydrocarbon compounds with subsequent introduction of the N function by addition to the epoxide group. The reaction of the epoxidized intermediate components with primary or secondary amines to form the corresponding alkanolamines may be of significance in this regard. In some embodiments, polyamines, particularly lower polyamines of the corresponding alkylenediamine type, are also suitable for opening of the epoxide ring.

Another class of the oleophilic amine compounds that may be suitable as emulsifiers are aminoamides derived from preferably long-chain carboxylic acids and polyfunctional, particularly lower, amines of the above-mentioned type. In some embodiments, at least one of the amino functions is not bound in amide form, but remains intact as a potentially salt-forming basic amino group. The basic amino groups, where they are formed as secondary or tertiary amino groups, may contain hydroxyalkyl substituents and, in particular, lower hydroxyalkyl substituents containing up to five and in some embodiments up to three carbon atoms in addition to the oleophilic part of the molecule.

According to some embodiments, suitable N-basic starting components for the preparation of such adducts containing long-chain oleophilic molecule constituents may include but are not limited to monoethanolamine or diethanolamine.

Weighting Agents

In some embodiments, weighting materials are also used to weight the drilling fluid additive to a desired density. In some embodiments, the drilling fluid is weighted to a density of about 8 to about 18 pounds per gallon and greater. Suitable weighting materials may include barite, ilmenite, calcium carbonate, iron oxide and lead sulfide. In some embodiments, commercially available barite is used as a weighting material.

Filtrate Reducers

In some embodiments, fluid loss control materials are added to the drilling fluid to control the seepage of drilling fluid into the formation. In some embodiments, fluid loss control materials are lignite-based or asphalt-based. Suitable filtrate reducers may include amine treated lignite, gilsonite and/or elastomers such as styrene butadiene.

Blending Process

In some embodiments, drilling fluids may contain about 0.1 pounds to about 15 pounds of the drilling fluid additive per barrel of fluids. In other embodiments, drilling fluids may contain about 0.1 pounds to about 10 pounds of the drilling fluid additive per barrel of fluids, and in still other embodiments, drilling fluids may contain about 0.1 pounds to about 5 pounds of the drilling fluid additive per-barrel of fluids. One of skill in the art will understand that “ppb” means pounds per barrel.

As shown above, a skilled artisan will readily recognize that additional additives such as weighting agents, emulsifiers, wetting agents, viscosifiers, fluid loss control agents, and other agents can be used with a composition according to the present invention. A number of other additives besides rheological additives regulating viscosity and anti-settling properties can also be used in the drilling fluid so as to obtain desired application properties, such as, for example, anti-settling agents and fluid loss-prevention additives.

In some embodiments, the drilling fluid additive can be cut or diluted with solvent to vary the pour point or product viscosity. Any suitable solvent or combination of solvents may be used. Suitable solvents may include but are not limited to: diesel, mineral or synthetic oils, block copolymers of EO/PO and/or styrene/isoprene, glycols including polyalkylene glycols, alcohols including polyethoxylated alcohols, polyethoxylated alkyl phenols or polyethoxylated fatty acids, various ethers, ketones, amines, amides, terpenes and esters.

As shown above, a skilled artisan will readily recognize that additional additives: weighting agents, emulsifiers, wetting agents, viscosifiers, fluid loss control agents, and other agents can be used with this invention. A number of other additives besides rheological additives regulating viscosity and anti-settling properties, providing other properties, can also be used in the fluid so as to obtain desired application properties, such as, for example, anti-settling agents and fluid loss-prevention additives.

Method of Use

In some embodiments, a polyamide drilling fluid additive, the various embodiments as discussed above, may be added to a drilling fluid. In some embodiments, the drilling fluid additive may be added to a drilling fluid in combination with other additives, such as organoclay rheology modifiers discussed above.

In some embodiments, a polyamide drilling fluid additive is added to a drilling fluid in an amount of about 0.1 pounds/barrel (“ppb”) to about 30 ppb of drilling fluid. In other embodiments, a polyamide drilling fluid additive is added to a drilling fluid in an amount of about 0.25 ppb to about 15.0 ppb drilling fluid. In other embodiments, a polyamide drilling fluid additive is added to a drilling fluid in an amount of about 0.25 ppb to about 5 ppb drilling fluid. In some embodiments, a polyamide drilling fluid additive is added to a drilling fluid in an amount of about 0.5 ppb drilling fluid. In some embodiments, a polyamide drilling fluid additive is added to a drilling fluid in an amount of about 0.75 ppb drilling fluid. In some embodiments, a polyamide drilling fluid additive is added to a drilling fluid in an amount of about 1.0 ppb drilling fluid. In some embodiments, a polyamide drilling fluid additive is added to a drilling fluid in an amount of about 1.5 ppb drilling fluid. In some embodiments, a polyamide drilling fluid additive is added to a drilling fluid in an amount of about 2.0 ppb drilling fluid. In some embodiments, a polyamide drilling fluid additive is added to a drilling fluid in an amount of about 5.0 ppb drilling fluid. In some embodiments, a smaller amount of a polyamide drilling fluid additive of the present invention is required to achieve comparable rheological stability results as a known drilling fluid additive.

The drilling fluid containing a polyamide drilling fluid additive may be characterized by several rheological or hydraulic aspects, i.e., ECD, high shear rate viscosity, low shear rate viscosity, plastic viscosity, regulating property viscosity, low shear rate yield point, yield point and Tau 0, of a drilling fluid. The rheological aspects may be determined using a Fann viscometer as per standard procedures found in API RP13B-2 “Standard Procedures for Field Testing Oil-based Drilling Fluids”. Viscosity readings can be measured at 600 rpm, 300 rpm, 200 rpm, 100 rpm, 6 rpm and 3 rpm. ECD can be determined by: standard hydraulics calculations found in API RP13D “Rheology and Hydraulics of Oil-well Drilling Fluids.” For the purposes of this invention high shear rate viscosity (“HSR”) corresponds to the dial reading measured at 600 rpm as per API RP13B-2 procedures. For the purposes of this invention, low shear rate viscosity (“LSR”) corresponds to the dial reading measured at 6 rpm as per API RP 13B-2 procedures. Plastic viscosity (“PV”) corresponds to the 600 rpm reading minus the 300 rpm reading. Yield Point (“YP”) corresponds to the 300 rpm reading minus plastic viscosity.

Each of the polyamide drilling fluid additive compositions described herein may be used to impart temperature stability to the rheology of an oil based drilling fluid. In some embodiments, the polyamide drilling fluid additive imparts temperature stability to the rheology, in particular the low shear rate viscosity, of the oil based drilling fluid. In some embodiments, the low shear rate viscosity measurement of the oil based drilling fluid containing a polyamide drilling additive does not change more than about ±20% between a measurement at a temperature of 120° F. and a measurement at a temperature of 150° F. In some embodiments, the low shear rate viscosity measurement of the oil based drilling fluid containing a polyamide drilling additive does not change more than about ±15%, about ±10%, or about ±8% between a measurement a temperature of 120° F. and a measurement a temperature of 150° F. In some embodiments, the low shear rate viscosity measurement of the oil based drilling fluid containing a polyamide drilling additive does not change more than about ±20%, about ±15%, about ±10%, or about ±8% between a measurement at a temperature of 120° F. and a measurement at a temperature of 150° F., where the measurements are taken after the oil based drilling fluid has been subjected to a hot rolled aging process, for example at a temperature of 300° F. or 150° F.

For the purposes of this application, the term “about” means plus or minus 10%.

### EXAMPLES

The following examples further describe and demonstrate illustrative embodiments within the scope of the present invention. The examples are given solely for illustration and are not to be construed as limitations of this invention as many variations are possible without departing from the spirit and scope thereof.

### Example 1

A drilling fluid additive was prepared as follows: To a 500 ml reaction kettle equipped with a nitrogen inlet, stirrer, Dean Stark trap and a condenser, a C₁₆-C₁₈ dimer carboxylic acid was charged and heated until a molten solid was obtained while stirring at 350 rpm. A polyamine having three amine functionalities was added, at a mole ratio of dimer carboxylic acid acid groups:amine groups ranging from 3:1 to 1:1, and mixed for 5 minutes after which time phosphoric acid was added. The reaction was heated at 200° C. for 6 hours or until the acid and amine values were less than 5. The reaction mixture was cooled to 135° C. and then discharged onto a cooling tray. Comparative 1.

### Example 2

A drilling fluid additive was prepared as follows: to a 500 ml reaction kettle equipped with a nitrogen inlet, stirrer, Dean Stark trap and a condenser, coconut fatty acid was charged and heated until a molten solid was obtained while stirring at 350 rpm. Diethylene triamine (MW=103) was added at a mole ratio of 3:1 and mixed for 5 minutes after which phosphoric acid was added. The reaction was heated at 200° C. for 6 hours. The reaction mixture was cooled to 135° C. and then discharged onto a cooling tray. Sample No. Comparative 2

### Example 3

A drilling fluid additive was prepared as follows: to a 500 ml reaction kettle equipped with a nitrogen inlet, stirrer, Dean Stark trap and a condenser, coconut fatty acid and Pripol® 1013 dimer acid were charged at a mole ratio of 3:1 and heated until a molten solid was obtained while stirring at 350 rpm. Diethylene triamine (MW=103) was added at a mole ratio of coconut fatty acid to DETA of 3:1 and mixed for 5 minutes after which phosphoric acid was added. The reaction was heated at 200° C. for 6 hours. The reaction mixture was cooled to 135° C. and then discharged onto a cooling tray. Sample No. 3267-91.

### Example 4

A drilling fluid additive was prepared as follows: to a 500 ml reaction kettle equipped with a nitrogen inlet, stirrer, Dean Stark trap and a condenser, coconut fatty acid, Pripol 1013 dimer acid, and Pripol® 1040 trimer acid were charged at a mole ratio of 15:4:1 and heated until a molten solid was obtained while stirring at 350 rpm. Diethylene triamine (MW=103) was added at a mole ratio of carboxylic acid groups of monocarboxylic acid:amine groups of 3:1 and mixed for 5 minutes after which phosphoric acid was added. The reaction was heated at 200° C. for 6 hours. The reaction mixture was cooled to 135° C. and then discharged onto a cooling tray. Sample No. 3419-19.

### Example 5

A drilling fluid additive was prepared as follows: to a 500 ml reaction kettle equipped with a nitrogen inlet, stirrer, Dean Stark trap and a condenser, coconut fatty acid, Pripol® 1013 dimer acid, and Pripol® 1040 trimer acid were charged at a mole ratio of 15:3:2 and heated until a molten solid was obtained while stirring at 350 rpm. Diethylene triamine (MW=103) was added at a mole ratio of carboxylic acid groups of monocarboxylic acid:amine groups of 3:1 and mixed for 5 minutes after which phosphoric acid was added. The reaction was heated at 200° C. for 6 hours. The reaction mixture was cooled to 135° C. and then discharged onto a cooling tray. Sample No. 3419-20.

### Example 6

A drilling fluid additive was prepared as follows: to a 500 ml reaction kettle equipped with a nitrogen inlet, stirrer, Dean Stark trap and a condenser, coconut fatty acid, Pripol® 1013 dimer acid, and Pripol® 1040 trimer acid were charged at a mole ratio of 15:2:3 and heated until a molten solid was obtained while stirring at 350 rpm. Diethylene triamine (MW=103) was added at a mole ratio of carboxylic acid groups of monocarboxylic acid:amine groups of 3:1 and mixed for 5 minutes after which phosphoric acid was added. The reaction was heated at 200° C. for 6 hours. The reaction mixture was cooled to 135° C. and then discharged onto a cooling tray. Sample No. 3422-10.

### Example 7

A drilling fluid additive was prepared as follows: to a 500 ml reaction kettle equipped with a nitrogen inlet, stirrer, Dean Stark trap and a condenser, coconut fatty acid, Pripol® 1013 dimer acid, and Pripol® 1040 trimer acid were charged at a mole ratio of 15:1:4 and heated until a molten solid was obtained while stirring at 350 rpm. Diethylene triamine (MW=103) was added at a mole ratio of carboxylic acid groups of monocarboxylic acid:amine groups of 3:1 and mixed for 5 minutes after which phosphoric acid was added. The reaction was heated at 200° C. for 6 hours. The reaction mixture was cooled to 135° C. and then discharged onto a cooling tray. Sample No. 3422-09.

### Example 8

A drilling fluid additive was prepared as follows: to a 500 ml reaction kettle equipped with a nitrogen inlet, stirrer, Dean Stark trap and a condenser, coconut fatty acid and Pripol 1040® trimer acid were charged at a mole ratio of 3:1 and heated until a molten solid was obtained while stirring at 350 rpm. Diethylene triamine (MW=103) was added at a mole ratio of carboxylic acid groups of monocarboxylic acid:amine groups of 3:1 and mixed for 5 minutes after which phosphoric acid was added. The reaction was heated at 200° C. for 6 hours. The reaction mixture was cooled to 135° C. and then discharged onto a cooling tray. Sample No. 3419-10.

### Example 9

A drilling fluid additive was prepared as follows: to a 500 ml reaction kettle equipped with a nitrogen inlet, stirrer, Dean Stark trap and a condenser, coconut fatty acid and a mixture of mono, dimer, and trimer, fatty acids were charged at a mole ratio of 3:1 and heated until a molten solid was obtained while stirring at 350 rpm. The mixture of mono, dimer, and trimer fatty acids was composed of 3.6 wt. % oleic acid, 89.8 wt. % Pripol® 1013 dimer acid, and 6.7 wt. % Pripol® 1040 trimer acid. Diethylene triamine (MW=103) was added at a mole ratio of carboxylic acid groups of monocarboxylic acid:amine groups of 3:1 and mixed for 5 minutes after which phosphoric acid was added. The reaction was heated at 200° C. for 6 hours. The reaction mixture was cooled to 135° C. and then discharged onto a cooling tray. Sample No. 3419-02.

### Example 10

A drilling fluid additive was prepared as follows: to a 500 ml reaction kettle equipped with a nitrogen inlet, stirrer, Dean Stark trap and a condenser, coconut fatty acid and a mixture of mono, dimer, and trimer, fatty acids were charged at a mole ratio of 3:1 and heated until a molten solid was obtained while stirring at 350 rpm. The mixture of mono, dimer, and trimer fatty acids was composed of 3.5 wt. % oleic acid, 96.07 wt. % Pripol® 1013 dimer acid, and 0.42 wt. % Pripol® 1040 trimer acid. Diethylene triamine (MW=103) was added at a mole ratio of carboxylic acid groups of monocarboxylic acid:amine groups of 3:1 and mixed for 5 minutes after which phosphoric acid was added. The reaction was heated at 200° C. for 6 hours. The reaction mixture was cooled to 135° C. and then discharged onto a cooling tray. Sample No. 3419-01.

### Example 11

A drilling fluid additive was prepared as follows: to a 500 ml reaction kettle equipped with a nitrogen inlet, stirrer, Dean Stark trap and a condenser, coconut fatty acid and CA2025 (a C₃₆ dimer acid) were charged at a mole ratio of 3:1 and heated until a molten solid was obtained while stirring at 350 rpm. Diethylene triamine (MW=103) was added at a mole ratio of carboxylic acid groups of monocarboxylic acid:amine groups of 3:1 and mixed for 5 minutes after which phosphoric acid was added. The reaction was heated at 200° C. for 6 hours. The reaction mixture was cooled to 135° C. and then discharged onto a cooling tray. Sample No. 3419-21.

### Example 12

A drilling fluid additive was prepared as follows: to a 500 ml reaction kettle equipped with a nitrogen inlet, stirrer, Dean Stark trap and a condenser, coconut fatty acid and CA2023 (a C₃₆ dimer acid) were charged at a mole ratio of 3:1 and heated until a molten solid was obtained while stirring at 350 rpm. Diethylene triamine (MW=103) was added at a mole ratio of carboxylic acid groups of monocarboxylic acid:amine groups of 3:1 and mixed for 5 minutes after which phosphoric acid was added. The reaction was heated at 200° C. for 6 hours. The reaction mixture was cooled to 135° C. and then discharged onto a cooling tray. Sample No. 3419-22.

### Example 13

A drilling fluid additive was prepared as follows: to a 500 ml reaction kettle equipped with a nitrogen inlet, stirrer, Dean Stark trap and a condenser, coconut fatty acid and CA2003 (a C₃₆ dimer acid) were charged at a mole ratio of 3:1 and heated until a molten solid was obtained while stirring at 350 rpm. Diethylene triamine (MW=103) was added at a mole ratio of carboxylic acid groups of monocarboxylic acid:amine groups of 3:1 and mixed for 5 minutes after which phosphoric acid was added. The reaction was heated at 200° C. for 6 hours. The reaction mixture was cooled to 135° C. and then discharged onto a cooling tray. Sample No. 3419-23.

### Example 14

A drilling fluid additive was prepared as follows: to a 500 ml reaction kettle equipped with a nitrogen inlet, stirrer, Dean Stark trap and a condenser, coconut fatty acid and Tsunodyme® 395 (a X dimer acid) were charged at a mole ratio of 3:1 and heated until a molten solid was obtained while stirring at 350 rpm. Diethylene triamine (MW=103) was added at a mole ratio of carboxylic acid groups of monocarboxylic acid:amine groups of 3:1 and mixed for 5 minutes after which phosphoric acid was added. The reaction was heated at 200° C. for 6 hours. The reaction mixture was cooled to 135° C. and then discharged onto a cooling tray. Sample No. 3267-78.

### Example 15

A drilling fluid additive was prepared as follows: to a 500 ml reaction kettle equipped with a nitrogen inlet, stirrer, Dean Stark trap and a condenser, coconut fatty acid and Tsunodyme® 395 (a X dimer acid) were charged at a mole ratio of 5:1 and heated until a molten solid was obtained while stirring at 350 rpm. Diethylene triamine (MW=103) was added at a mole ratio of carboxylic acid groups of monocarboxylic acid:amine groups of 5:1 and mixed for 5 minutes after which phosphoric acid was added. The reaction was heated at 200° C. for 6 hours. The reaction mixture was cooled to 135° C. and then discharged onto a cooling tray. Sample No. 3422-31.

### Example 16

A drilling fluid additive was prepared as follows: to a 500 ml reaction kettle equipped with a nitrogen inlet, stirrer, Dean Stark trap and a condenser, palmitic acid and Tsunodyme® 395 (a X dimer acid) were charged at a mole ratio of 3:1 and heated until a molten solid was obtained while stirring at 350 rpm. Diethylene triamine (MW=103) was added at a mole ratio of carboxylic acid groups of monocarboxylic acid:amine groups of 3:1 and mixed for 5 minutes after which phosphoric acid was added. The reaction was heated at 200° C. for 6 hours. The reaction mixture was cooled to 135° C. and then discharged onto a cooling tray. Sample No. 3422-32.

### Example 17

A drilling fluid additive was prepared as follows: to a 500 ml reaction kettle equipped with a nitrogen inlet, stirrer, Dean Stark trap and a condenser, palmitic acid and Tsunodyme® 395 (a X dimer acid) were charged at a mole ratio of 5:1 and heated until a molten solid was obtained while stirring at 350 rpm. Diethylene triamine (MW=103) was added at a mole ratio of carboxylic acid groups of monocarboxylic acid:amine groups of 5:1 and mixed for 5 minutes after which phosphoric acid was added. The reaction was heated at 200° C. for 6 hours. The reaction mixture was cooled to 135° C. and then discharged onto a cooling tray. Sample No. 3422-33.

### Example 18

A drilling fluid additive was prepared as follows: to a 500 ml reaction kettle equipped with a nitrogen inlet, stirrer, Dean Stark trap and a condenser, coconut fatty acid and Tsunodyme® 395 (a X dimer acid) were charged at a mole ratio of 5:1 and heated until a molten solid was obtained while stirring at 350 rpm. Tetraethylene pentamine (MW=189.30) was added at a mole ratio of carboxylic acid groups of monocarboxylic acid:amine groups of 5:1 and mixed for 5 minutes after which phosphoric acid was added. The reaction was heated at 200° C. for 6 hours. The reaction mixture was cooled to 135° C. and then discharged onto a cooling tray. Sample No. 3422-34.

### Example 19

A drilling fluid additive was prepared as follows: to a 500 ml reaction kettle equipped with a nitrogen inlet, stirrer, Dean Stark trap and a condenser, coconut fatty acid and Tsunodyme® 395 (a X dimer acid) were charged at a mole ratio of 3:1 and heated until a molten solid was obtained while stirring at 350 rpm. Tetraethylene pentamine (MW=189.30) was added at a mole ratio of carboxylic acid groups of monocarboxylic acid:amine groups of 3:1 and mixed for 5 minutes after which phosphoric acid was added. The reaction was heated at 200° C. for 6 hours. The reaction mixture was cooled to 135° C. and then discharged onto a cooling tray. Sample No. 3422-35.

### Example 20

A drilling fluid additive was prepared as follows: to a 500 ml reaction kettle equipped with a nitrogen inlet, stirrer, Dean Stark trap and a condenser, palmitic acid and Tsunodyme® 395 (a X dimer acid) were charged at a mole ratio of 3:1 and heated until a molten solid was obtained while stirring at 350 rpm. Tetraethylene pentamine (MW=189.30) was added at a mole ratio of carboxylic acid groups of monocarboxylic acid:amine groups of 3:1 and mixed for 5 minutes after which phosphoric acid was added. The reaction was heated at 200° C. for 6 hours. The reaction mixture was cooled to 135° C. and then discharged onto a cooling tray. Sample No. 3422-40.

### Example 21

A drilling fluid additive was prepared as follows: to a 500 ml reaction kettle equipped with a nitrogen inlet, stirrer, Dean Stark trap and a condenser, palmitic acid and Tsunodyme® 395 (a X dimer acid) were charged at a mole ratio of 5:1 and heated until a molten solid was obtained while stirring at 350 rpm. Tetraethylene pentamine (MW=189.30) was added at a mole ratio of carboxylic acid groups of monocarboxylic acid:amine groups of 3:1 and mixed for 5 minutes after which phosphoric acid was added. The reaction was heated at 200° C. for 6 hours. The reaction mixture was cooled to 135° C. and then discharged onto a cooling tray. Sample No. 3422-41.

### Example 22

A drilling fluid additive was prepared as follows: to a 500 ml reaction kettle equipped with a nitrogen inlet, stirrer, Dean Stark trap and a condenser, coconut fatty acid and Radiacid 0958 dimer acid were charged at a mole ratio of 3:1 and heated until a molten solid was obtained while stirring at 350 rpm. Diethylene triamine (MW=103) was added at a mole ratio of coconut fatty acid to DETA of 3:1 and mixed for 5 minutes after which phosphoric acid was added. The reaction was heated at 200° C. for 6 hours. The reaction mixture was cooled to 135° C. and then discharged onto a cooling tray. Sample No. 3419-27.

### Example 23

### Testing of Polyamide Compositions

Drilling fluids containing the polyamide compositions were prepared for evaluation based on various formulations shown in Table 1.

TABLE 1
Drilling Fluid Formulations

| | |
|---|---|
| Mud Weight | 12 ppg |
| No. 2 Diesel | 171.7 g |
| Amine Type Emulsifier | 10 g |
| 25% CaCl2 | 73.5 g |
| Lime | 4 g |
| Bentone ® 910 | 6 g |
| Barite | 241 g |

Viscosity measurements of the drilling fluids of Table 1 were measured using the OFI-900 at 120° F. and 150° F. after each thermal cycle using test procedures API RP 13B, using standard malt cups and a 5 spindle Hamilton Beach® multimixer at 6 RPM. Results are shown in Table 2.

The drilling fluids of Table 1 were dynamically aged using a roller oven for 16 hours at 150° F. After the drilling fluids were water cooled for one hour, the fluids were mixed on a Hamilton Beach® MultiMixer for 10 minutes. Viscosity measurements of the drilling fluids were measured using the OFI-900 at 120° F. and 150° F. after each thermal cycle using test procedures API RP 13B. Results are shown in Table 2.

TABLE 2
OFI 900 Visc. - 6 RPM Readings

| | | Initial | Initial | HR 150° F. | HR 150° F. |
|---|---|---|---|---|---|
| | Load | Test | Test | Test | Test |
| | Level | Temp. | Temp. | Temp. | Temp. |
| Sample | (ppb) | 120° F. | 150° F. | 120° F. | 150° F. |
| Comparative 1 | 2.0 | 17 | 11 | 17 | 11 |
| Comparative 2 | 1.0 | 19 | 11 | 18 | 11 |
| Comparative 2 | 2.0 | 23 | 11 | 21 | 12 |
| Comparative 2 | 3.0 | 28 | 12 | 27 | 12 |
| 3419-27 | 1.0 | 16 | 16 | 15 | 15 |
| 3419-27 | 2.0 | 20 | 21 | 20 | 21 |
| 3419-27 | 3.0 | 24 | 23 | 25 | 24 |
| 3267-91 | 3.0 | 24 | 20 | 23 | 23 |
| 3419-19 | 3.0 | 25 | 23 | 22 | 25 |
| 3419-20 | 3.0 | 24 | 23 | 22 | 23 |
| 3422-10 | 3.0 | 23 | 25 | 22 | 25 |
| 3422-09 | 3.0 | 23 | 25 | 21 | 23 |
| 3419-10 | 3.0 | 23 | 25 | 19 | 24 |
| 3419-02 | 3.0 | 25 | 21 | 23 | 23 |
| 3419-01 | 3.0 | 25 | 21 | 25 | 25 |
| 3419-21 | 3.0 | 24 | 20 | 23 | 20 |
| 3419-22 | 3.0 | 23 | 21 | 24 | 23 |
| 3419-23 | 3.0 | 25 | 22 | 23 | 22 |
| 3267-78 | 3.0 | 23 | 19 | 23 | 22 |
| 3422-31 | 3.0 | 20 | 18 | 19 | 17 |
| 3422-32 | 3.0 | 19 | 16 | 17 | 14 |
| 3422-33 | 3.0 | 17 | 17 | 18 | 16 |
| 3422-34 | 3.0 | 25 | 27 | 19 | 23 |
| 3422-35 | 3.0 | 19 | 21 | 21 | 26 |

The data in Table 2 demonstrates that it is possible to reduce the change in 6 rpm viscosity over a change in temperature, by using a dicarboxylic acid and/or tricarboxylic acid in combination with a monocarboxylic acid and amine as a polyamide drilling fluid additive. As illustrated in Table 2, a drilling fluid containing dimer acid and trimer acid in addition to mono acid and amine had a change in 6 rpm viscosity ranging from 0% to 20%, over a change in temperature from 120° F. to 150° F. In contrast, a drilling fluid containing mono acid and amine but no dimer acid or trimer acid had a change in 6 rpm viscosity ranging from 38% to 50%, over a change in temperature from 120° F. to 150° F.

The present disclosure may be embodied in other specific forms without departing from the spirit or essential attributes of the disclosure. Accordingly, reference should be made to the appended claims, rather than the foregoing specification, as indicating the scope of the disclosure. Although the foregoing description is directed to the preferred embodiments of the disclosure, it is noted that other variations and modifications will be apparent to those skilled in the art, and may be made without departing from the spirit or scope of the disclosure.

We claim:

1. A method of drilling in a subterranean formation comprising the steps of:
(a) providing an oil based drilling fluid by combining an oil based continuous phase with a drilling fluid additive, said drilling fluid additive comprising a polyamide having constituent units of:
i. a first carboxylic acid unit having a single carboxylic moiety
ii. a second carboxylic acid unit selected from the group consisting of a second carboxylic acid unit having two carboxylic moieties, a second carboxylic acid unit having three carboxylic moieties and combinations thereof; and
iii. a polyamine unit having at least two primary amino groups and optionally at least one secondary amino group,
wherein a viscosity measurement of the oil based drilling fluid does not change more than about ±20% between a measurement at a temperature of 120° F. and a measurement at a temperature of 150° F.;
(b) placing the oil based drilling fluid into the subterranean formation.

2. The method of claim 1, wherein the first carboxylic acid unit is derived from one or more compounds of the formula R¹—COOH wherein R¹ is a saturated or unsaturated hydrocarbon having from 8 carbon atoms to 22 carbon atoms.

3. The method of claim 2, wherein R¹ is an unsaturated hydrocarbon having from 8 carbon atoms to 22 carbon atoms and wherein R¹ is optionally substituted with one or more hydroxyl groups.

4. The method of claim 1, wherein the first carboxylic acid unit is derived from one or more compounds of the formula R¹—COOH wherein R¹ is a saturated or unsaturated hydrocarbon having from 12 carbon atoms to 22 carbon atoms.

5. The method of claim 4, wherein R¹ is an unsaturated hydrocarbon having from 12 carbon atoms to 22 carbon atoms and wherein R¹ is optionally substituted with one or more hydroxyl groups.

6. The method of claim 1, wherein the first carboxylic acid unit is derived from a monocarboxylic acid selected from the group consisting of: dodecanoic acid, tetradecanoic acid, hexadecanoic acid, octadecanoic acid, eicosanoic acid, docosanoic acid, 12-hydroxy-octadecanoic acid, and 12-hydroxy-9-cis-octadecenoic acid and mixtures thereof.

7. The method of claim 1, wherein the first carboxylic acid is coconut fatty acid.

8. The method of claim 1, wherein the second carboxylic acid unit having two carboxylic moieties is derived from a dimer fatty acid.

9. The method of claim 8, wherein dimer fatty acid is selected from the group consisting of hydrogenated, partially hydrogenated and non-hydrogenated dimer acids with from about 20 to about 48 carbon atoms.

10. The method of claim 1, wherein the polyamine unit is derived from a linear or branched aliphatic or aromatic diamine having from 2 to 36 carbon atoms.

11. The method of claim 10, wherein the polyamine unit is derived from a polyamine selected from a group consisting of ethylenediamine, tetramethylenediamine, pentamethylenediamine, hexamethylenediamine, diethylenetriamine, metaxylene diamine and mixtures thereof.

12. The method of claim 1, further comprising adding one or more emulsifiers to the oil-based drilling fluid.

13. The method of claim 1, further comprising adding an organoclay to the oil-based drilling fluid.

14. The method of claim 1, wherein the oil based continuous phase is selected from the group consisting of: diesel oil, mineral oil, synthetic oil, vegetable oil, fish oil, paraffinics, ester-based oils and combinations thereof.

15. The method of claim 1, further comprising adding a non-organoclay rheological additive to the oil-based drilling fluid.

16. The method of claim 1, further comprising adding a fluid loss reducing additive to the oil-based drilling fluid.

17. The method of claim 1, comprising adding the polyamide drilling fluid additive to the oil-based drilling fluid at a concentration ranging from 0.5 ppb to 5 ppb.

18. A method of drilling in a subterranean formation comprising the steps of:
(a) providing an oil based drilling fluid by combining an oil based continuous phase with a drilling fluid additive comprising a polyamide which is a reaction product of:
i. a first carboxylic acid having a single carboxylic moiety
ii. a second carboxylic acid selected from the group consisting of a second carboxylic acid having two carboxylic moieties, a second carboxylic acid having three carboxylic moieties and combinations thereof; and
iii. a polyamine having at least two primary amino groups and optionally at least one secondary amino group,
wherein a viscosity measurement of the oil based drilling fluid does not change more than about ±20% between a measurement at a temperature of 120° F. and a measurement at a temperature of 150° F.;
(b) placing the oil based drilling fluid into the subterranean formation.

19. The method of claim 18, wherein the first carboxylic acid has a formula R¹—COOH wherein R¹ is a saturated or unsaturated hydrocarbon having from 8 carbon atoms to 22 carbon atoms.

20. The method of claim 19, wherein R¹ is an unsaturated hydrocarbon having from 8 carbon atoms to 22 carbon atoms and wherein R¹ is optionally substituted with one or more hydroxyl groups.

21. The method of claim 18, wherein the first carboxylic acid is derived from one or more compounds of the formula R¹—COOH wherein R¹ is a saturated or unsaturated hydrocarbon having from 12 carbon atoms to 22 carbon atoms.

22. The method of claim 21, wherein R¹ is an unsaturated hydrocarbon having from 12 carbon atoms to 22 carbon atoms and wherein R¹ is optionally substituted with one or more hydroxyl groups.

23. The method of claim 18, wherein the first carboxylic acid is selected from the group consisting of: dodecanoic acid, tetradecanoic acid, hexadecanoic acid, octadecanoic acid, eicosanoic acid, docosanoic acid, 12-hydroxy-octadecanoic acid, and 12-hydroxy-9-cis-octadecenoic acid and mixtures thereof.

24. The method of claim 18, wherein the first carboxylic acid is coconut fatty acid.

25. The method of claim 18, wherein the polyamine comprises a linear or branched aliphatic or aromatic diamine having from 2 to 36 carbon atoms.

26. The method of claim 24, wherein the polyamine selected from a group consisting of ethylenediamine, tetramethylenediamine, pentamethylenediamine, hexamethylenediamine, diethylenetriamine, metaxylene diamine and mixtures thereof.
